(19) United States
(12) Patent Application Publication
(10) Pub. No.: US 2025/0256709 A1
(43) Pub. Date: Aug. 14, 2025

(54) SIGNAL-BASED AUTO GAP PERSONALIZED ADAPTIVE CRUISE CONTROL ADJUSTMENT FOR DRIVER COMFORT

(71) Applicant: TOYOTA MOTOR ENGINEERING & MANUFACTURING NORTH AMERICA, INC., Plano, TX (US)

(72) Inventors: Rohit GUPTA, Santa Clara, CA (US); Amr ABDELRAOUF, Redwood City, CA (US); Kyungtae HAN, Palo Alto, CA (US); Shili SHENG, Charlottesville, VA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/437,060

(22) Filed: Feb. 8, 2024

(51) Int. Cl. B60W 30/14

(52) U.S. Cl. CPC B60W 30/14; B60W 2420/403; B60W 2420/408; B60W 2420/50; B60W 2420/54; B60W 2540/22; B60W 2555/20

(57) ABSTRACT

Systems and methods are provided for generating a personalized Adaptive Cruise Control (ACC) setting for driver comfort. The systems and methods may receive environmental data and driver data of a driver from a vehicle. The systems and methods may detect a signal indicative of driver discomfort. The systems and methods may determine a discomfort level of the driver according to the signal. The systems and methods may generate the personalized ACC setting for the driver according to the discomfort level, environmental data and driver data. The systems and methods may adjust the personalized ACC setting according to a change in the discomfort level of the driver. The systems and methods may send the personalized ACC setting to the vehicle for implementation. The systems and methods may store the personalized ACC setting for the driver in a driver preference database.

### TECHNICAL FIELD

The present disclosure relates generally to the field of advanced driver-assistance systems (ADAS), and more particularly some implementations relate to systems and methods for generating a personalized adaptive cruise control (ACC) setting for driver comfort.

### BACKGROUND OF THE INVENTION

Vehicles may be used as a means of transportation for the public. Vehicles may include automobiles, trucks, motorcycles, bicycles, scooters, mopeds, recreational vehicles and other like on- or off-road vehicles. Vehicles may further include autonomous, semi-autonomous and manual vehicles.

Currently, most vehicles include a cruise control system. The cruise control system is a system that automatically controls the speed of a vehicle. The driver of a vehicle may use the cruise control system to set a desired speed and the cruise control system will control the throttle of the vehicle to maintain the speed without any outside intervention (e.g., pressing the accelerator pedal). The settings of the cruise control system may be controlled by the driver using various buttons and may be deactivated by pressing the brake pedal.

Most conventional vehicles include sensors, both internal and external to the respective vehicle. Such sensors may be used to collect data of various objects, vehicles, and components. The sensors may also be used to monitor traffic and road conditions. An evolution of the cruise control system is the adaptive cruise control (ACC) system, which is a type of advanced driver-assistance system (ADAS) for vehicles that utilizes sensors of a vehicle. The ACC system allows a vehicle to maintain a user-defined/set speed when a road ahead is clear, and switches to distance control when another vehicle or obstacle is detected using one or more sensors of the respective vehicle. While there are benefits to the ACC system, issues exist with its acceptance by drivers. This is because ACC systems are not generally perceived as being completely safe, nor providing/taking into account driver comfort. A solution to the ACC system is needed to automatically adjust the speed of a vehicle according to a driver's comfort level in order to allow the vehicle to operate automatically without any external or driver interference due to the driver being uncomfortable.

### BRIEF SUMMARY OF THE DISCLOSURE

According to various aspects of the disclosed technology, systems and methods for generating a personalized adaptive cruise control (ACC) setting for driver comfort are provided.

In accordance with some implementations, a method for generating a personalized adaptive cruise control (ACC) setting for driver comfort is provided. The method may include: receiving environmental data of a vehicle and driver data of a driver of the vehicle; detecting a signal indicative of driver discomfort; determining a discomfort level of the driver according to the signal; generating the personalized ACC setting for the driver according to the discomfort level, environmental data and driver data; sending, to the vehicle, the personalized ACC setting for the vehicle to implement; and storing the personalized ACC setting for the driver in a driver preference database.

In some applications, the environmental data, the driver data and the signal are obtained from a sensor of the vehicle.

In some applications, the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the environmental data comprises a time, weather, road condition and traffic.

In some applications, the driver data comprises a location of the vehicle, direction of movement of the vehicle, driver identification and driver performance characteristic.

In some applications, the personalized ACC setting is adjusted according to a change in the discomfort level of the driver.

In some applications, the signal indicative of driver discomfort is a proximity of an actuating member of the driver relative to a motion actuator of the vehicle.

In some applications, the method may further include: obtaining the personalized ACC setting according to the environmental data and driver data; sending, to the vehicle, the personalized ACC setting for the vehicle to implement; detecting a second signal indicative of driver discomfort; determining a second discomfort level of the driver according to the second signal; updating the personalized ACC setting according to the second discomfort level, environmental data and driver data; sending, to the vehicle, the updated personalized ACC setting for the vehicle to implement; and storing the updated personalized ACC setting in the driver preference database.

In another aspect, a system for generating a personalized adaptive cruise control (ACC) setting for driver comfort is provided that may include one or more processors; and memory coupled to the one or more processors to store instructions, which when executed by the one or more processors, may cause the one or more processors to perform operations. The operations may include: receiving environmental data of a vehicle and driver data of a driver of the vehicle; detecting a signal indicative of driver discomfort; determining a discomfort level of the driver according to the signal; generating the personalized ACC setting for the driver according to the discomfort level, environmental data and driver data; sending, to the vehicle, the personalized ACC setting for the vehicle to implement; and storing the personalized ACC setting for the driver in a driver preference database.

In some applications, the environmental data, the driver data and the signal are obtained from a sensor of the vehicle.

In some applications, the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the environmental data comprises a time, weather, road condition and traffic.

In some applications, the driver data comprises a location of the vehicle, direction of movement of the vehicle, driver identification and driver performance characteristic.

In some applications, the personalized ACC setting is adjusted according to a change in the discomfort level of the driver.

In some applications, the signal indicative of driver discomfort is a proximity of an actuating member of the driver relative to a motion actuator of the vehicle.

In some applications, the system may further include operations comprising: obtaining the personalized ACC setting according to the environmental data and driver data; sending, to the vehicle, the personalized ACC setting for the vehicle to implement; detecting a second indicative of driver discomfort; determining a second discomfort level of the driver according to the second signal; updating the personalized ACC setting according to the second discomfort level, environmental data and driver data; sending, to the vehicle, the updated personalized ACC setting for the vehicle to implement; and storing the updated personalized ACC setting in the driver preference database.

In another aspect, a non-transitory machine-readable medium is provided. The non-transitory computer-readable medium may include instructions that when executed by a processor may cause the processor to perform operations including: receiving environmental data of a vehicle and driver data of a driver of the vehicle; detecting a signal indicative of driver discomfort; determining a discomfort level of the driver according to the signal; generating a personalized ACC setting for the driver according to the discomfort level, environmental data and driver data; sending, to the vehicle, the personalized ACC setting for the vehicle to implement; and storing the personalized ACC setting for the driver in a driver preference database.

In some applications, the environmental data, the driver data and the signal are obtained from a sensor of the vehicle.

In some applications, the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the environmental data comprises a time, weather, road condition and traffic.

In some applications, the driver data comprises a location of the vehicle, direction of movement of the vehicle, driver identification and driver performance characteristic.

In some applications, the personalized ACC setting is adjusted according to a change in the discomfort level of the driver.

In some applications, the signal indicative of driver discomfort is a proximity of an actuating member of the driver relative to a motion actuator of the vehicle.

In some applications, the non-transitory machine-readable medium may further include operations comprising: obtaining the personalized ACC setting according to the environmental data and driver data; sending, to the vehicle, the personalized ACC setting for the vehicle to implement; detecting a second signal indicative of driver discomfort; determining a second discomfort level of the driver according to the second signal; updating the personalized ACC setting according to the second discomfort level, environmental data and driver data; sending, to the vehicle, the updated personalized ACC setting for the vehicle to implement; and storing the updated personalized ACC setting in the driver preference database.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 is an example illustration of a computing system for generating a personalized Adaptive Cruise Control (ACC) setting for driver comfort, according to example applications described in the present disclosure.

FIG. 2 is an example illustration of a vehicle with which applications of the disclosed technology may be implemented.

FIG. 3 is an example illustration of a system for generating a personalized ACC setting for driver comfort, according to example applications described in the present disclosure.

FIG. 4 is an example illustration of a process for generating a personalized ACC setting for driver comfort, according to example applications described in the present disclosure.

FIG. 5 is an example illustration of a computing component that includes one or more hardware processors and machine-readable storage media storing a set of machine-readable/machine-executable instructions that, when executed, cause the one or more hardware processors to perform an illustrative method for generating a personalized ACC setting for driver comfort, according to example embodiments described in the present disclosure.

FIG. 6 is an example illustration of a computing component that may be used to implement various features of embodiments described in the present disclosure.

The figures are not exhaustive and do not limit the present disclosure to the precise form disclosed.

### DETAILED DESCRIPTION

As described above, most conventional vehicles include one or more sensors, both internal and external to the respective vehicle. Such sensors may be used to collect data of various objects, vehicles, and components. The sensors may also be used to monitor traffic and road conditions. An adaptive cruise control (ACC) system, which is a type of advanced driver-assistance system (ADAS) for vehicles that utilizes sensors of a vehicle, may be used to allow a vehicle to maintain a user-defined/set speed when a road ahead is clear, and switches to distance control when another vehicle or obstacle is detected using one or more sensors of the respective vehicle. The ACC system may automatically adjust the speed of a vehicle in order to maintain a safe distance from vehicles or obstacles ahead, without any external or driver interference. While there are benefits to the ACC system, issues exist with its acceptance by drivers. This is because ACC systems are not generally perceived as being completely safe, given that an ACC system may completely substitute a driver's control of a vehicle.

Aspects of the technology disclosed herein may provide systems and methods configured to generate a personalized adaptive cruise control (ACC) setting for driver comfort. A personalized ACC system may use one or more sensors of one or more vehicles to collect data of roads to evaluate road conditions, traffic, environmental conditions, etc. (“environmental data”). The personalized ACC system may use algorithms to accurately evaluate environmental data to detect one or more obstructions and vehicles ahead of an ego vehicle. The personalized ACC system may use one or more sensors of an ego vehicle to collect data of the driver of the ego vehicle, including, for example, driver identity, driver characteristics, driving performance, ego vehicle location, direction of movement of the ego vehicle, etc. (“driver data”). The personalized ACC system may use one or more sensors of an ego vehicle to determine a discomfort level of the driver of the ego vehicle by detecting one or more signals indicative of driver discomfort. The signal indicative of driver discomfort may be detected when an actuating member of the driver (e.g., a foot of the driver) is in a proximity relative to a motion actuator of the vehicle (e.g., a brake pedal, accelerator pedal). In particular, aspects of the systems and methods disclosed herein may be configured to determine a driver's discomfort level when driving in an ego vehicle and generate one or more personalized ACC settings for the driver according to the environmental data, driver data and discomfort level to establish driver comfort.

A plurality of vehicles traveling on a road at a particular location may collect environmental data at the particular location, such as the time, weather, road conditions, traffic, etc. The plurality of vehicles may include, for example, automobiles, trucks, motorcycles, bicycles, scooters, mopeds, recreational vehicles and other like on- or off-road vehicles. The plurality of vehicles may include, for example, an autonomous, semi-autonomous and manual operation. Each of the plurality of vehicles may include one or more sensors that may be used to collect environmental data. An ego vehicle may include one or more sensors that may be used to collect environmental data including, for example, the time (e.g., minute, hour, day, month, and year), weather, road condition, and traffic. Each road may also include one or more sensors that may be used to collect environmental data. The sensors may include, for example, cameras, image sensors, radar sensors, environmental sensors, light detection and ranging (LiDAR) sensors, position sensors, audio sensors, infrared sensors, microwave sensors, optical sensors, haptic sensors, magnetometers, communication systems and global positioning systems (GPS). Data may be received by at least one sensor of a vehicle. The personalized ACC system may use one or more sensors of a plurality of vehicles to collect environmental data. The personalized ACC system may also use one or more sensors on the road (e.g., road sensors) to collect environmental data. The environmental data collected by a vehicle may be associated with a location of the vehicle. The plurality of environmental data collected by a plurality of vehicles at or around the same location may be associated, integrated, and combined with one another to accurately record the environmental data.

The environmental data of a particular location may include information on the condition of the road, damage to the road, hazardous features present on or proximate to the road, other attributes and characteristics of the road (e.g., the color, size, number of lanes, shape, etc.), traffic, number of vehicles on the road, and average speed of vehicles on the road. The environmental data obtained from one or more sensors of an ego vehicle of the plurality of vehicles and from one or more road sensors on the road may be analyzed by the personalized ACC system. Analyzing the environmental data may detect one or more obstructions present on or proximate to the road that the ego vehicle traveled on. An obstruction may include, for example, a pothole, crack, tire marking, faded road marking, debris, object, occlusion, road reflection, flooding, icy surface, oil leak, uneven pavement, erosion and raveling.

Each obstruction may be detected by the personalized ACC system according to one or more attributes and characteristics of the road. Different attributes and characteristics of the road may represent various types of obstructions. The types of obstructions and the associated attributes and characteristics of the road for each type of obstruction may be preset and stored in a database. The types of obstructions and the associated attributes and characteristics of the road for each type of obstruction may be updated according to algorithms and models using the environmental data received from various vehicles and various road sensors.

The analyzed environmental data may be used to generate a personalized ACC setting for a driver of an ego vehicle at the particular location. The environmental data of a particular location may vary according to the time of day, day of the week, and week and month of the year. The personalized ACC system may generate various personalized ACC settings for a driver of an ego vehicle according to the various environmental data collected by sensors of vehicles and road sensors on roads. In some examples, a driver of an ego vehicle may drive on road X between the hours of 6:00 am to 7:00 am and 5:00 pm to 6:00 pm every day of the year. The environmental data collected between the hours of 6:00 am to 7:00 am may be different from the environmental data collected between the hours of 5:00 pm to 6:00 pm. The environmental data collected between the hours of 6:00 am to 7:00 am on a Monday may differ from the environmental data collected between the hours of 5:00 pm to 6:00 pm on a Thursday. The environmental data collected between the hours of 6:00 am to 7:00 am on a Monday in December may differ from the environmental data collected between the hours of 6:00 am to 7:00 am on a Monday in August. The personalized ACC system may generate a personalized ACC setting for the driver of the ego vehicle for road X for each of the various environmental data collected at the different time periods. Many variations are possible.

While obstructions, road conditions, traffic, and other environmental characteristics may be detected by the personalized ACC system by analyzing initially collected environmental data, by an ego vehicle using one or more sensors and road sensors, such detected environmental characteristics may not be fully accurate. The initially collected environmental data obtained by one or more sensors of the ego vehicle and one or more road sensors on the road may be interrupted by noise causing inaccuracy in the detection of one or more environmental characteristics. The environmental characteristics detected from the initially collected environmental data may also change over time where, for example, traffic may disappear or get worse, causing inaccuracy in the flow of traffic detected from the initially collected environmental data. To determine whether environmental characteristics are accurately detected and recorded, the personalized ACC system may use a subset of additional vehicles to verify the environmental data. The subset of additional vehicles may include a plurality of vehicles different from the ego vehicle that obtained the initially collected environmental data.

The subset of additional vehicles may be selected by the personalized ACC system to verify the environmental data. The subset of additional vehicles may include, for example, automobiles, trucks, motorcycles, bicycles, scooters, mopeds, recreational vehicles and other like on- or off-road vehicles. The subset of additional vehicles may include, for example, an autonomous, semi-autonomous and manual operation. The subset of additional vehicles may include one or more vehicles within a distance threshold to the ego vehicle. The distance threshold may be a preset. The distance threshold may vary according to the location of the ego vehicle. The distance threshold may vary according to the time of day. The distance threshold may be updated according to algorithms and models using driving data of vehicles. Many variations are possible.

The subset of additional vehicles may also include one or more vehicles enroute to the ego vehicle. A vehicle may be determined to be enroute to the ego vehicle according to the vehicle's location and direction of movement. A vehicle may be determined to be enroute to the ego vehicle according to a GPS of the vehicle. The GPS of the vehicle may include instructions and directions of a route that the vehicle may follow to reach a particular destination that is enroute to the location of the ego vehicle. The instructions and directions of the route of the GPS may include the location of the ego vehicle.

The subset of additional vehicles may further include one or more vehicles that have one or more sensors capable of collecting environmental data. One or more sensors, either individually or in combination, may be able to collect environmental data to verify the environmental characteristics. The one or more sensors of each of the subset of vehicles used to collect the environmental k, for example, a camera, image sensor, radar sensor, environmental sensor, light detection and ranging (LiDAR) sensor, position sensor, audio sensor, infrared sensor, microwave sensor, optical sensor, haptic sensor, magnetometer, communication system and global positioning system (GPS). The environmental data collected by the subset of vehicles at or around the same location may be associated, integrated, and combined together and with the environmental data collected by the ego vehicle and a plurality of other vehicles to accurately record the environmental data.

The subset of additional vehicles may further include one or more vehicles based on performance data of the respective vehicle with regards to how accurately the respective vehicle follows navigation directions. The subset of additional vehicles may further include one or more vehicles that are associated with the personalized ACC system.

The personalized ACC system may receive driver data on a driver of an ego vehicle. The driver data may include information, for example, the identification of the driver, characteristics of the driver (e.g., mood, driving skills, behaviors, etc.), driving performance (i.e., the driver's ability to navigate in various situations and environments), location of the ego vehicle (e.g., geographical location, lane of travel of the ego vehicle, etc.), direction of movement of the ego vehicle (e.g., destination, cardinal direction, etc.), and any other information related to the driver and driving performance of the ego vehicle. The driver data may be obtained from one or more sensors of the ego vehicle. The sensors may include, for example, cameras, image sensors, radar sensors, environmental sensors, light detection and ranging (LiDAR) sensors, position sensors, audio sensors, infrared sensors, microwave sensors, optical sensors, haptic sensors, magnetometers, communication systems and global positioning systems (GPS).

The driver data obtained from one or more sensors of an ego vehicle may be analyzed by the personalized ACC system. Analyzing the driver data may determine one or more driving preferences of the driver. The one or more driving preferences of the driver may be pre-stored in a database of the personalized ACC system. The one or more driving preferences of the driver may be set by the driver. The one or more driving preferences of the driver may be determined by the personalized ACC system according to one or more analysis of the driver's driving performance and driver characteristics.

The analyzed driver data may be used to generate a personalized ACC setting for a driver of an ego vehicle. The driver data may vary according to the location of the ego vehicle, the direction of movement of the ego vehicle, etc. The personalized ACC system may generate various personalized ACC settings for a driver of an ego vehicle according to the various driver data collected by sensors of the ego vehicle. The personalized ACC system may use the driver data and the environmental data collected at a particular time and particular location of an ego vehicle to generate a personalized ACC setting for the driver of the ego vehicle. Many variations are possible.

The personalized ACC system may use one or more internal sensors of an ego vehicle to detect one or more signals indicative of driver discomfort of a driver of the ego vehicle. The one or more driver discomfort signals may be detected when an actuating member of the driver (e.g., a foot of the driver) is in a proximity relative to a motion actuator of the vehicle (e.g., a brake pedal, accelerator pedal). The one or more driver discomfort signals may indicate a degree of discomfort that the driver is experiencing while the ego vehicle is operating. The one or more driver discomfort signals of the driver may be detected when a foot of the driver is hovering over or pressing on a brake pedal of the ego vehicle. A foot of a driver may hover over or press on the brake pedal of the ego vehicle when the driver is feeling uncomfortable while driving the ego vehicle. The driver may feel uncomfortable while driving the ego vehicle for various reasons, including, for example, bad weather, slow traffic, obstructions on the road, body irritation, etc. The one or more driver discomfort signals of the driver may be detected when a foot of the driver is hovering over or pressing on an acceleration pedal of the ego vehicle. The foot of the driver may press on or hover over the acceleration pedal of the ego vehicle when the driver is feeling highly comfortable while driving the ego vehicle. The one or more driver discomfort signals of the driver may indicate that a foot of the driver is placed away from the brake pedal and the acceleration pedal of the ego vehicle. A foot of the driver may be placed away from the brake pedal and the acceleration pedal when the driver is feeling neutrally comfortable while driving the vehicle. The driver may feel comfortable, whether highly or neutrally, while driving the ego vehicle for various reasons, including, for example, good weather, no traffic, no obstructions on the road, being happy, etc.

The internal sensors of the ego vehicle may include, for example, cameras, radar sensors, electromyography sensors, motion sensors, pressure sensors, position sensors, and microwave sensors. The internal sensors may be located inside the ego vehicle and positioned in a manner to monitor the feet of the driver of the ego vehicle. As an example, a first camera may be located near the brake pedal and a second camera may be located near the acceleration pedal. As another example, a pressure sensor or electromyography sensor may be located on or in the driver seat to monitor muscle tension and movement of a leg of the driver to determine movement of a foot of the driver. Many variations are possible. The discomfort level of the driver may be determined according to the degree of discomfort of the driver that is determined from the one or more driver discomfort signals.

The personalized ACC system may analyze the driver discomfort signals detected by the internal sensors of the ego vehicle to determine a discomfort level of the driver of the ego vehicle. The discomfort level may be determined according to one or more factors of the driver discomfort signals, including, for example, the type of driver discomfort signals (e.g., brake pedal signal, acceleration pedal signal, and neutral position signal), the duration of each driver discomfort signal, the frequency of the driver discomfort signals (i.e., the rate of repetition of the brake pedal signals), the strength of the driver discomfort signals, etc. The discomfort level may be determined according to the driver data and the environmental data obtained at the same time or around the same time as the detection of the driver discomfort signals. Many variations are possible.

The personalized ACC system may use the driver data, environmental data and discomfort level of the driver in the ego vehicle to generate a personalized ACC setting for the driver. The personalized ACC setting for the driver may be a particular driving setting of the ego vehicle according to particular environmental data and driver data at a particular time, that the driver may feel comfortable for the ego vehicle to operate in. As an example, the personalized ACC setting for the driver may include a particular speed limit for the ego vehicle, a particular distance threshold of space between the ego vehicle and a leading vehicle, and a particular lane of traffic for the ego vehicle to operate in when the ego vehicle is operating on a particular road with particular driver data and particular environmental data that may place the driver in a comfortable and safe state. In this way, the ego vehicle may be able to automatically operate according to the personalized ACC setting without the driver's interference, and without the driver feeling uncomfortable. Various personalized ACC settings for the driver may be generated according to various combinations of environmental data, driver data, and discomfort level.

The personalized ACC system may store the various personalized ACC settings for the driver in a database. The personalized ACC system may retrieve a personalized ACC setting for the driver according to environmental data and driver data obtained by the one or more sensors of the ego vehicle. In this way, the personalized ACC setting may be able to use previously generated personalized ACC settings for the driver according to various sets of environmental data and driver data.

When the ego vehicle is operating according to a personalized ACC setting for the driver of the ego vehicle, one or more data of the environmental data or driver data may change. The ego vehicle may receive the updated environmental data or updated driver data and retrieve a stored personalized ACC setting from the database that matches the new set of data of the environmental data and driver data. The ego vehicle may update its operations to the newly retrieved stored personalized ACC setting from the database.

When the ego vehicle is operating according to a personalized ACC setting for the driver of the ego vehicle, one or more new driver discomfort signals of the driver may be detected. A new discomfort level of the driver may be determined according to the new driver discomfort signals. The personalized ACC setting may be updated according to the new discomfort level of the driver. The updated personalized ACC setting may be stored in the database. In this way, the personalized ACC settings for the driver stored in the database may accurately reflect the driving performance preferences of the driver to allow the ego vehicle to operate without interference from the driver, and without the driver feeling uncomfortable and unsafe.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

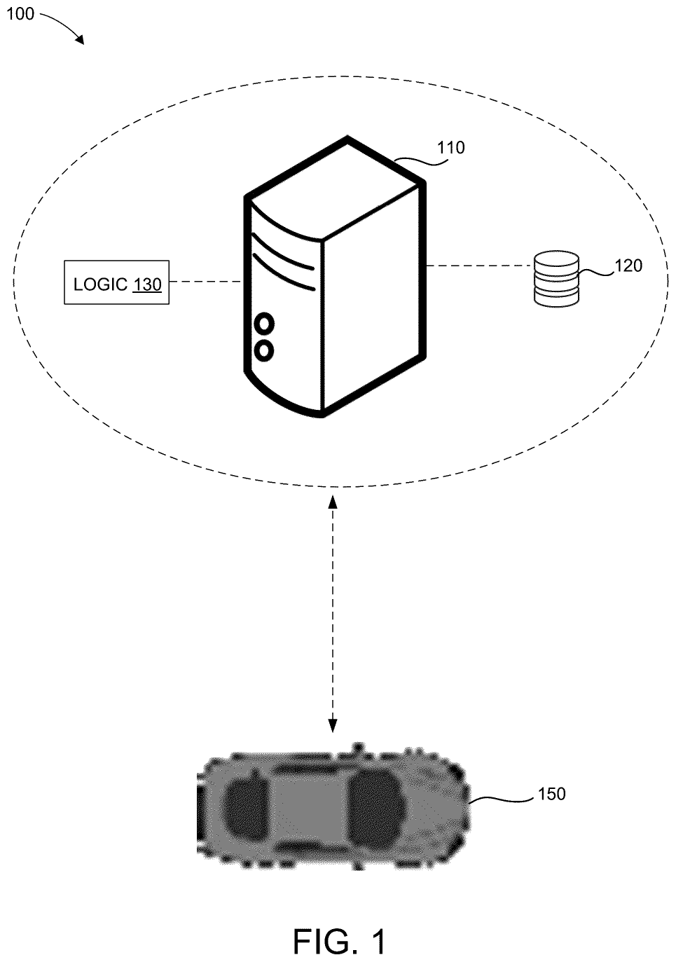

FIG. 1 illustrates an example of a computing system 100 which may be internal or otherwise associated within a vehicle 150. In some embodiments, the computing system 100 may be a machine learning (ML) pipeline and model, and use ML algorithms. In some examples, the vehicle 150 may be a vehicle, such as an automobile, truck, motorcycle, bicycle, scooter, moped, recreational vehicle and other like on- or off-road vehicles. The vehicle 150 may input data into computing component 110. The computing component 110 may perform one or more available operations on the input data to generate outputs, such as detecting driver discomfort signals, determining discomfort levels, and generating and implementing personalized ACC settings. The vehicle 150 may further display the outputs on a Graphical User Interface (GUI). The GUI may be in vehicle 150 or on a computing device, such as a desktop computer, a laptop, a mobile phone, a tablet device, an Internet of Things (IoT) device, etc. The GUI may display the outputs as a two-dimensional (2D) and three-dimensional (3D) layout and map showing the various outputs generated by algorithms, such as ML algorithms, based on various input data, such as sensor data of the environment, driver, and driver discomfort signals from vehicle 150.

The computing system 110 in the illustrated example may include one or more processors and logic 130 that implements instructions to carryout the functions of the computing component 110, for example, receiving environmental data of a vehicle and driver data of a driver of the vehicle, detecting a signal indicative of driver discomfort, determining a discomfort level of the driver according to the signal, generating a personalized ACC setting for the driver according to the discomfort level, environmental data and driver data, sending the personalized ACC setting to the vehicle for implementation, and storing the personalized ACC setting for the driver in a driver preference database. The computing component 110 may store, in a database 120, details regarding scenarios or conditions in which some algorithms, image datasets, and assessments are performed and used to detect driver discomfort signals, determine discomfort levels, and generate and implement personalized ACC settings. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of vehicles, road, and drivers to better evaluate the environment around an ego vehicle and a driver of the ego vehicle, detect driver discomfort signals of the driver, determine discomfort levels of the driver, and generate and implement personalized ACC settings for the driver to allow the ego vehicle to operate without driver interference.

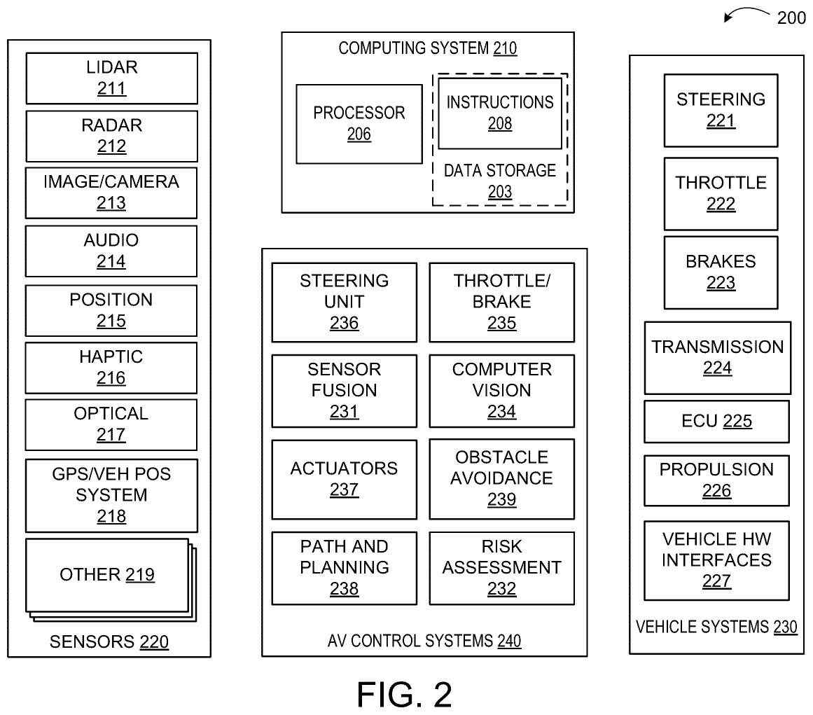

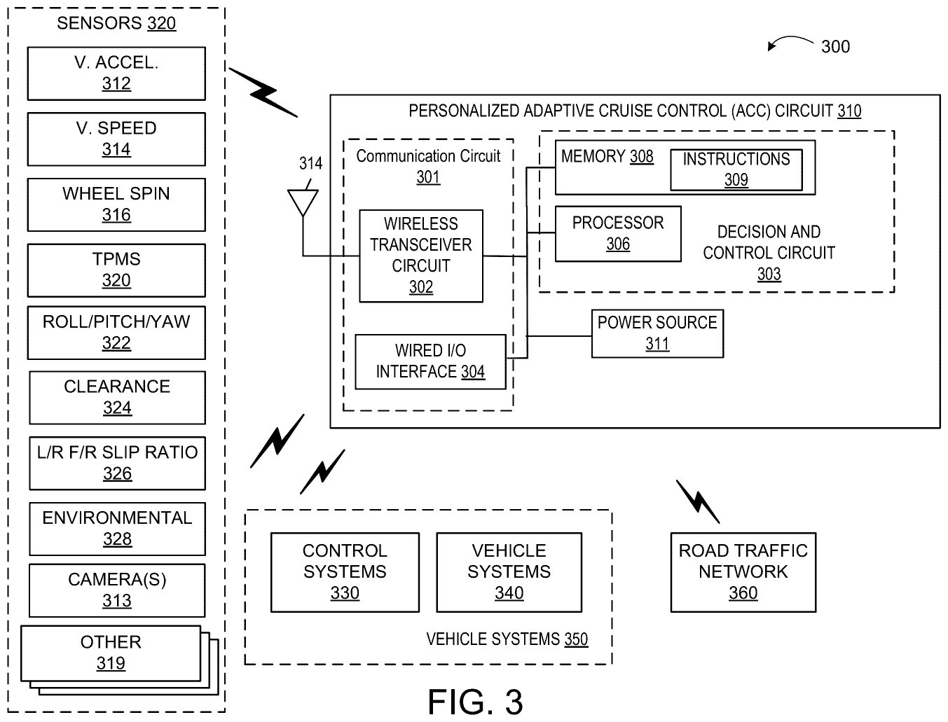

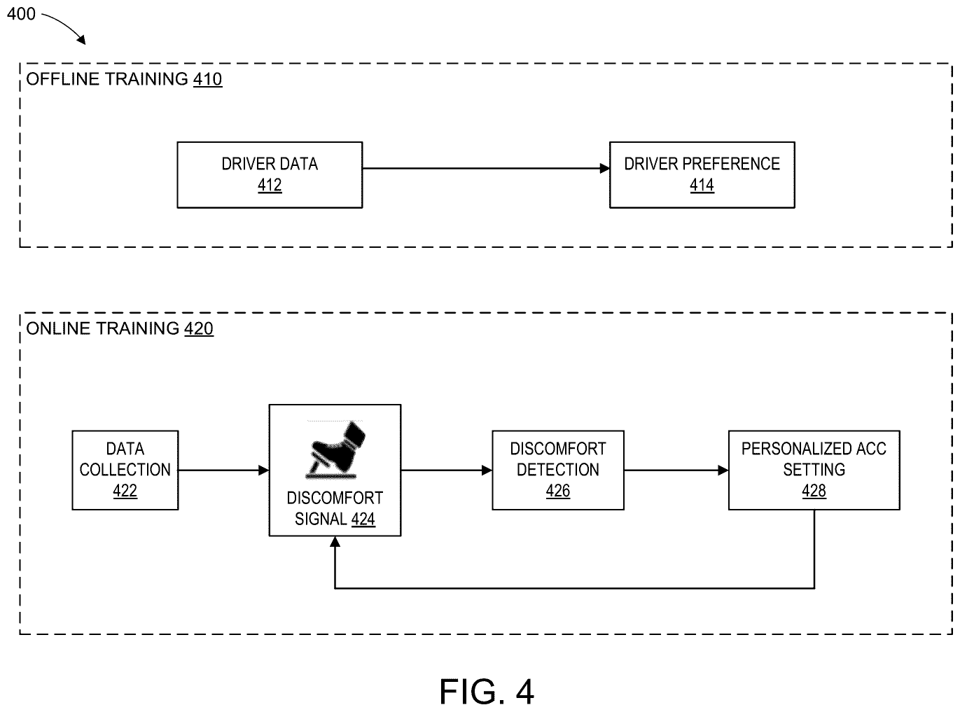

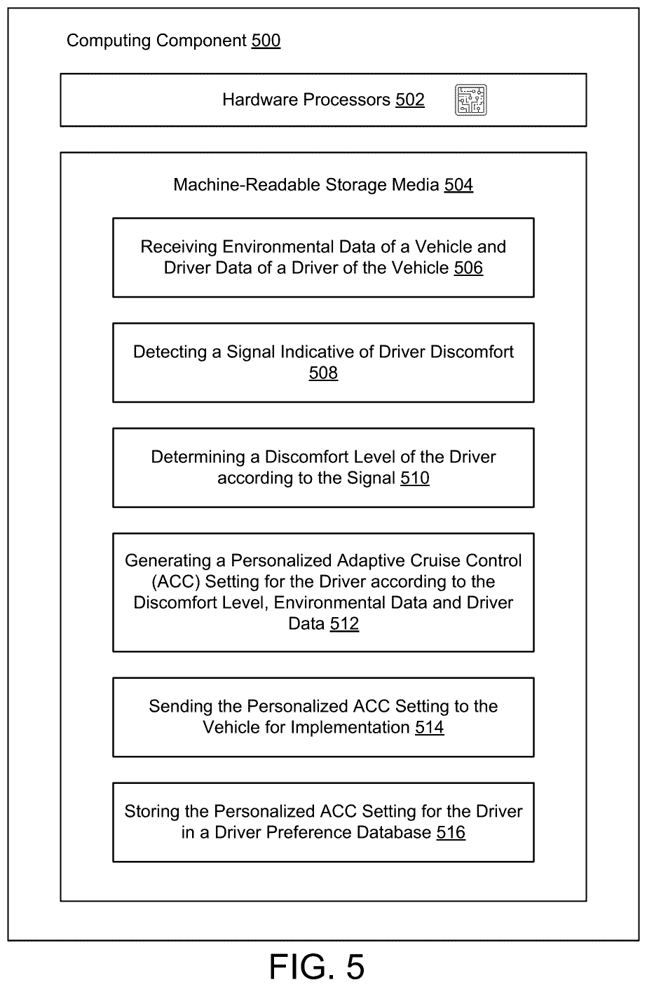

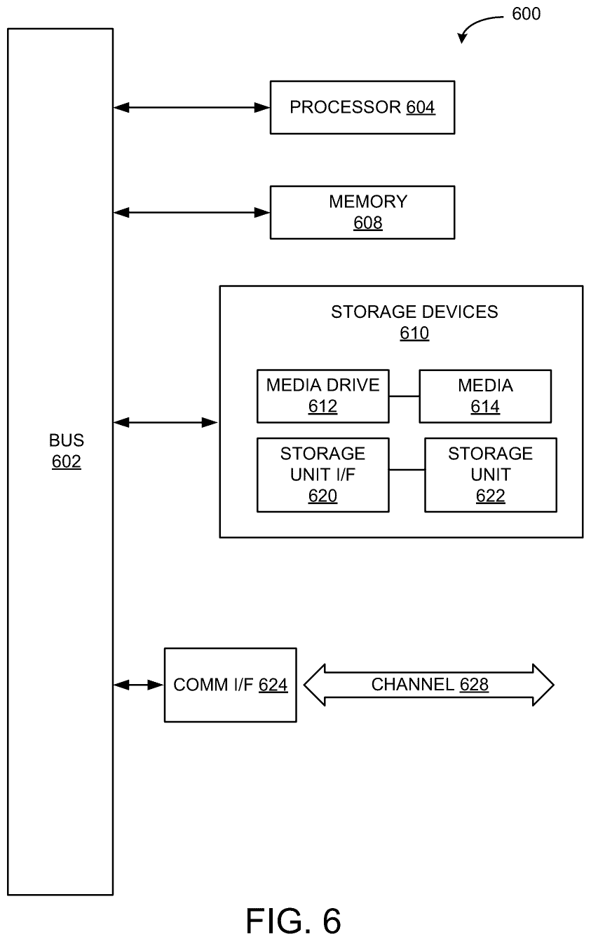

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components. The computing component 110 may be, for example, the computing system 210 of FIG. 2, the personalized ACC system 300 of FIG. 3, the process 400 of FIG. 4, the computing component 500 of FIG. 5 and the computing component 600 of FIG. 6.

FIG. 2 illustrates an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on- or off-road vehicles, that may include an autonomous, semi-autonomous and manual operation. The vehicle 200 may include components, such as a computing system 210, sensors 220, AV control systems 240 and vehicle systems 230. Either of the computing system 210, sensors 220, AV control systems 240, and vehicle systems 230 can be part of an automated vehicle system/advanced driver assistance system (ADAS). ADAS can provide navigation control signals (i.e., control signals to actuate the vehicle and operate one or more vehicle systems 230 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for detecting and responding to intervening obstacles may not require many sensors. It can also be understood that system and methods described herein can be augmented by sensors off the vehicle 200. In this example, sensors 220 include light detection and ranging (LiDAR) sensor 211, radar sensor 212, image sensors 213 (e.g., a camera), audio sensors 214, position sensor 215, haptic sensor 216, optical sensor 217, a Global Positioning System (GPS) or other vehicle positioning system 218, and other like distance measurement and environment sensing sensors 219. Sensors 220 may further include internal signals including, for example, electromyography sensors, motion sensors, pressure sensors, microwave sensors, etc. One or more of the sensors 220 may gather data, such as environmental data, driver data, and driver discomfort signals, and send that data to the vehicle electronic control unit (ECU) or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as weather and road surfaces, as well as internal to the vehicle. Information from image sensors 213 (e.g., camera) can be used to determine information about the environment surrounding the vehicle 200 including, for example, information regarding weather, road surfaces and other objects surrounding vehicle 200. For example, image sensors 213 may be able to recognize specific vehicles (e.g., color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions.

Vehicle positioning system 218 (e.g., GPS or other positioning system) can be used to gather position information about a current location of the vehicle as well as other positioning or navigation information, such as the positioning information about a current location and direction of movement of the vehicle according to a particular road.

Other sensors 219 may be provided as well. Other sensors 219 can include vehicle acceleration sensors, vehicle speed sensors, wheelspin sensors (i.e., one for each wheel), tire pressure monitoring sensors (i.e., one for each tire), vehicle clearance sensors, left-right and front-rear slip ratio sensors, environmental sensors (i.e., to detect weather, traction conditions, or other environmental conditions), seat pressure monitoring sensors (i.e., in the driver seat to measure muscle tension of the driver), motion sensors, electromyography sensors, and microwave sensors. Other sensors 219 can be further included for a given implementation of ADAS. Various sensors 220, such as other sensors 219, may be used to provide input to computing system 210 and other systems of vehicle 200 so that the systems have information useful to determine a discomfort level of the driver and generate personalized ACC settings for the driver.

AV control systems 240 may include a plurality of different systems/subsystems to control operation of vehicle 200. In this example, AV control systems 240 can include, autonomous driving module (not shown), steering unit 236, throttle and brake control unit 235, sensor fusion module 231, computer vision module 234, path and planning module 238, obstacle avoidance module 239, risk assessment module 232 and actuator(s) 237. Sensor fusion module 231 can be included to evaluate data from a plurality of sensors, including sensors 220. Sensor fusion module 231 may use computing system 210 or its own computing system to execute algorithms to assess inputs from the various sensors.

Throttle and brake control unit 235 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (i.e., such as in a hybrid or electric vehicle) to slow or stop the vehicle.

Steering unit 236 may include any of a number of different mechanisms to control or alter the heading of the vehicle. For example, steering unit 236 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 236.

Computer vision module 234 may be included to process image data (e.g., image data captured from image sensors 213, or other image data) to evaluate the environment within or surrounding the vehicle. For example, algorithms operating as part of computer vision module 234 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 234 may be able to model the road traffic vehicle network, predict incoming hazards and obstacles, predict road hazard, and determine one or more contributing factors to identifying obstructions. Computer vision module 234 may be able to perform depth estimation, image/video segmentation, camera localization, and object classification according to various classification techniques (including by applied neural networks).

Path and planning module 238 may be included to compute a desired path for vehicle 200 based on input from various other sensors and systems. For example, path and planning module 238 can use information from positioning system 218, sensor fusion module 231, computer vision module 234, obstacle avoidance module 239 (described below) and other systems (e.g., AV control systems 240, sensors 220, and vehicle systems 230) to determine a safe path to navigate the vehicle along a segment of a desired route. Path and planning module 238 may also be configured to dynamically update the vehicle path as real-time information is received from sensors 220 and other control systems 240.

Obstacle avoidance module 239 can be included to determine control inputs necessary to avoid obstacles and obstructions detected by sensors 220 or AV control systems 240. Obstacle avoidance module 239 can work in conjunction with path and planning module 238 to determine an appropriate path to avoid and navigate around obstacles and obstructions.

Path and planning module 238 (either alone or in conjunction with one or more other module of AV control systems 240, such as obstacle avoidance module 239, computer vision module 234, and sensor fusion module 231) may also be configured to perform and coordinate one or more vehicle maneuvers. Example vehicle maneuvers can include at least one of a path tracking, stabilization and collision avoidance maneuver. With connected vehicles, vehicle maneuvers can be performed at least partially cooperatively between the connected vehicles to gather a sufficient amount of data of the environment, including obstructions and traffic. A sufficient amount of data of an obstruction may include collecting data of the obstruction at various angles and perspectives. Each different type of obstruction may warrant a different amount of data to be collected and analyzed to make the needed determinations to verify the obstruction and determine the condition of traffic. For example, data needed to verify a small obstruction, like a small pothole, may be minimal as the connected vehicles collecting verification data of the small pothole obstruction may only need to collect data of missing asphalt on the road. The data needed to verify a larger obstruction, like a downed traffic light, may be much more extensive as the connected vehicles collecting verification data of the downed traffic light obstruction may need to collect data of the portion of the roadway blocked by the downed traffic light, electrical issues present on the roadway, disrupted traffic flow caused by the downed traffic light, including, for example, any other vehicles or objects blocking traffic due to the downed traffic light, additional obstructions on the road caused by the downed traffic light, including, for example, cracks, potholes, debris, etc., and so on. Hence, those of ordinary skill in the art will understand what sufficient means in the context of collecting a sufficient amount of data to verify an obstruction to determine the condition of traffic.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 230 can provide vehicle control systems to vehicle hardware interfaces for controlled systems such as steering angle 221, brakes 223, throttle 222, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle and its systems and subsystems for operation, including operation of vehicle 200 in the autonomous, semi-autonomous or manual modes. For example, memory 203 can include data that has been communicated to the ego vehicle (e.g., via V2V (vehicle-to-vehicle) communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in detecting and verifying obstructions, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 237 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 238 can allow for executing one or more vehicle control mode(s), and vehicle control algorithms in accordance with various implementations of the systems and methods disclosed herein.

In operation, path and planning module 238 (e.g., by a driver intent estimation module, not shown) can receive information regarding human control input used to operate the vehicle. As described above, information from sensors 220, actuators 237 and other systems can be used to determine the type and level of human control input. Path and planning module 238 can use this information to predict driver action. Path and planning module 238 can use this information to generate a predicted path and model the road traffic vehicle network. This may be useful in evaluating road conditions, determining and verifying obstructions, and determining traffic conditions. As also described above, information from sensors, and other systems can be used to evaluate road conditions, determine and verify obstructions, and determine traffic conditions. Eye state tracking, attention tracking, or intoxication level tracking, for example, can be used to determine vehicle movement patterns according to inherent human behavior. It can be understood that the driver state and discomfort level can contribute to generating a personalized ACC setting as disclosed herein. Driver state can be provided to a risk assessment module 232 to determine the level of risk associated with a vehicle operation, and detecting driver discomfort. Although not illustrated in FIG. 2, where the assessed risk contributes to determining vehicle movement patterns according to inherent human behaviors, a verification strategy may be generated and provided to vehicle 200 to determine traffic conditions.

Path and planning module 238 can receive state information such as, for example from visibility maps, traffic and weather information, hazard maps, and local map views. Information from a navigation system can also provide a mission plan including maps and routing to path and planning module 238.

The path and planning module 238 (e.g., by a driver intent estimation module, not shown) can receive this information and predict behavior characteristics within a future time horizon. This information can be used by path and planning module 238 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 238 can generate an expected model for the road traffic hazards and assist in creating a predicted traffic hazard level and verification strategy for vehicles to implement.

Path and planning module 238 can receive risk information from risk assessment module 232. Path and planning module 238 can receive vehicle capability and capacity information from one or more vehicle systems 230. Vehicle capability can be assessed, for example, by receiving information from vehicle hardware interfaces 229 to determine vehicle capabilities and identify a reachable set model. Path and planning module 238 can receive surrounding environment information (e.g., from computer vision module 234, and obstacle avoidance module 239). Path and planning module 238 can apply risk information and vehicle capability and capacity information to trajectory information (e.g., based on a planned trajectory and driver intent) to determine a safe or optimized trajectory for the vehicle given the drivers intent, policies (e.g., safety or vehicle cooperation policies), communicated information, given one or more obstacles in the surrounding environment, road conditions, traffic conditions, etc. This trajectory information can be provided to controller (e.g., ECU 225) to provide partial or full vehicle control in the event of a risk level above threshold. A signal from risk assessment module 232 can be used generate countermeasures described herein. A signal from risk assessment module 232 can trigger ECU 225 or another AV control system 230 to take over partial or full control of the vehicle.

FIG. 3 illustrates an example architecture for generating personalized adaptive cruise control (ACC) settings described herein. Referring now to FIG. 3, in this example, a personalized ACC system 300 includes a personalized ACC circuit 310, a plurality of sensors 320, and a plurality of vehicle systems 350. Also included are various elements of road traffic network 360 with which the personalized ACC system 300 can communicate. It can be understood that a road traffic network 360 can include various elements that are navigating and important in navigating a road traffic network, such as vehicles, pedestrians (with or without connected devices that can include aspects of personalized ACC system 300 disclosed herein), or infrastructure (e.g., traffic signals, sensors, such as traffic cameras, databases, central servers, weather sensors). Other elements of the road traffic network 360 can include connected elements at workplaces, or the home (such as vehicle chargers, connected devices, appliances, etc.).

Personalized ACC system 300 can be implemented as and include one or more components of the vehicle 200 shown in FIG. 2. Sensors 320, vehicle systems 350, and elements of road traffic network 360, can communicate with the personalized ACC circuit 310 via a wired or wireless communication interface. As previously alluded to, elements of road traffic network 360 can correspond to connected or unconnected devices, infrastructure (e.g., traffic signals, sensors, such as traffic cameras, weather sensors), vehicles, pedestrians, obstacles, etc. that are in a broad or immediate vicinity of ego-vehicle (e.g., vehicle 150, vehicle 200) or otherwise important to the navigation of the road traffic network (such as remote infrastructure). Although sensors 320, vehicle systems 350, and road traffic network 360, are depicted as communicating with personalized ACC circuit 310, they can also communicate with each other, as well as with other vehicle systems 350 and directly with element of a road traffic network 360. Data as disclosed herein can be communicated to and from the personalized ACC circuit 310. For example, various infrastructure (example element of road traffic network 360) can include one or more databases, such as vehicle crash data or weather data. This data can be communicated to the circuit 310, and such data can be updated based on outcomes for one or more maneuvers or navigation of the road traffic network, vehicle telematics, driver state (physical and mental), vehicle data from sensors 320 (e.g., tire pressure or brake status) from the vehicle. Similarly, traffic data, vehicle state data, time of travel, demographics data for drivers can be retrieved and updated. All of this data can be included in and contribute to predictive analytics (e.g., by machine learning) of accident possibility, and determinations of road conditions and poor, hazard road conditions. Similarly, models, circuits, and predictive analytics can be updated according to various outcomes.

Personalized ACC circuit 310 can evaluate road conditions, detect an obstruction, determine traffic conditions, determine driver discomfort levels and generate personalized ACC settings as described herein. As will be described in more detail herein, the detection of obstructions, evaluation of road conditions, determination of traffic conditions and determination of driver discomfort levels can have one or more contributing factors. Various sensors 320, vehicle systems 350, and road traffic network 360 elements may contribute to gathering data for evaluating road conditions, detecting obstructions, determining traffic conditions, and determining driver discomfort levels. For example, the personalized ACC circuit 310 can include at least one of an obstruction detection and response circuit. The personalized ACC circuit 310 can be implemented as an ECU or as part of an ECU such as, for example electronic control unit 225. In other applications, personalized ACC circuit 310 can be implemented independently of the ECU, for example, as another vehicle system.

Personalized ACC circuit 310 can be configured to evaluate road conditions, detect obstructions, determine traffic conditions, determine driver discomfort levels and appropriately respond by generating personalized ACC settings. Personalized ACC circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed personalized ACC circuit 310 can be compatible with and support one or more standard or non-standard messaging protocols.

Components of personalized ACC circuit 310 are illustrated as communicating with each other via a data bus, although other communication in interfaces can be included. Decision and control circuit 303 can be configured to control one or more aspects of obstruction detection and response. Decision and control circuit 303 can be configured to execute one or more steps described with reference to FIG. 4 and FIG. 5.

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of personalized ACC circuit 310. For example, data and other information can include vehicle driving data, such as a determined familiarity of the driver with driving and the vehicle. The data can also include values for signals of one or more sensors 320 useful in evaluating road conditions, detecting obstructions, determining traffic conditions, determining driver discomfort levels and generating personalized ACC settings. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a personalized ACC circuit 310. Components of decision and control circuit 303 can be distributed among two or more decision and control circuits 303, performed on other circuits described with respect to personalized ACC circuit 310, be performed on devices (such as cell phones) performed on a cloud-based platform (e.g., part of infrastructure), performed on distributed elements of the road traffic network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with personalized ACC circuit 310 can include either or both wired and wireless communications circuits 301. Wireless transceiver circuit 302 can include a transmitter and a receiver (not shown), e.g., an obstruction detection and verification broadcast mechanism, to allow wireless communications via any of a number of communication protocols such as, for example, WiFi (e.g., IEEE 802.11 standard), Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by road condition detection and verification circuit 310 to/from other components of the vehicle, such as sensors 320, vehicle systems 350, infrastructure (e.g., servers cloud-based systems), and other devices or elements of road traffic network 360. These RF signals can include information of almost any sort that is sent or received by vehicle.

Wired I/O interface 304 can include a transmitter and a receiver (not shown) for hardwired communications with other devices. For example, wired I/O interface 304 can provide a hardwired interface to other components, including sensors 320 and vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the vehicle, such as a battery and alternator. Power source 311 can be used to power the personalized ACC circuit 310.

Sensors 320 can include one or more of the previously mentioned sensors 220 of FIG. 2. Sensors 320 can include one or more sensors that may or not otherwise be included on a standard vehicle (e.g., vehicle 200) with which the personalized ACC circuit 310 is implemented. In the illustrated example, sensors 320 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 313 (e.g., front rear, side, top, bottom facing). Additional sensors 319 can also be included as may be appropriate for a given implementation personalized ACC system 300.

Vehicle systems 350 can include any of a number of different vehicle components or subsystems used to control or monitor various aspects of the vehicle and its performance. For example, it can include any or all of the aforementioned vehicle systems 230 and control systems 240 shown in FIG. 2. In this example, the vehicle systems 350 may include a GPS or other vehicle positioning system 218.

During operation, personalized ACC circuit 310 can receive information from various vehicle sensors 320, vehicle systems 350, and road traffic network 360 to evaluate road conditions, detect obstructions, determine traffic conditions, determine driver discomfort levels and generate personalized ACC settings. Also, the driver, owner, and operator of the vehicle may manually trigger one or more processes described herein for evaluating road conditions, detecting obstructions, determining traffic conditions, determining driver discomfort levels and generating personalized ACC settings. Communication circuit 301 can be used to transmit and receive information between the personalized ACC circuit 310, sensors 320 and vehicle systems 350. Also, sensors 320 and personalized ACC circuit 310 may communicate with vehicle systems 350 directly or indirectly (e.g., via communication circuit 301 or otherwise). Communication circuit 301 can be used to transmit and receive information between personalized ACC circuit 310, one or more other systems of a vehicle 200, but also other elements of a road traffic network 360, such as vehicles, devices (e.g., mobile phones), systems, networks (such as a communications network and central server), and infrastructure.

In various applications, communication circuit 301 can be configured to receive data and other information from sensors 320 and vehicle systems 350 that is used evaluating road conditions, detecting obstructions, determining traffic conditions, determining driver discomfort levels, and generating and implementing personalized ACC settings. As one example, when data is received from an element of road traffic network 360 (such as from a driver's user device), communication circuit 301 can be used to send an activation signal and activation information to one or more vehicle systems 350 or sensors 320 for the vehicle to determine traffic conditions. For example, it may be useful for vehicle systems 350 or sensors 320 to provide data useful in determining traffic conditions. Alternatively, personalized ACC circuit 310 can be continuously receiving information from vehicle system 350, sensors 320, other vehicles, devices and infrastructure (e.g., those that are elements of road traffic network 360). Further, upon detecting an obstruction, communication circuit 301 can send a signal to other components of the vehicle, infrastructure, or other elements of the road traffic network based on the detection of the obstruction. For example, the communication circuit 301 can send a signal to a vehicle system 350 that indicates a control input for performing one or more vehicle movement patterns to navigate around the obstruction according to the type of road condition. In some applications upon detecting an obstruction, depending on the type of road condition, the driver's control of the vehicle can be prohibited, and control of the vehicle can be offloaded to the ADAS. In more specific examples, upon detection of an obstruction (e.g., by sensors 320, and vehicle system 350 or by elements of the road traffic network 360), one or more signals can be sent to a vehicle system 350, so that an assist mode can be activated and the vehicle can control one or more of vehicle systems 230 (e.g., steering system 221, throttle system 222, brakes 223, transmission 224, ECU 225, propulsion system 226, suspension, and powertrain).

The examples of FIGS. 2 and 3 are provided for illustration purposes only as examples of vehicle 200 and personalized ACC system 300 with which applications of the disclosed technology may be implemented. One of ordinary skill in the art reading this description will understand how the disclosed applications can be implemented with vehicle platforms.

FIG. 4 illustrates an example process 400 that includes one or more steps that may be performed to generate and implement personalized ACC settings. In some applications, the process 400 can be executed, for example by the computing component 110 of FIG. 1. In another application, the process 400 may be implemented as the computing component 110 of FIG. 1. In other applications, the process 400 may be implemented as, for example, the computing system 210 of FIG. 2, and the personalized ACC system 300 of FIG. 3. The process 400 may include a server.

At step 410, the computing component 110 may perform offline training. The computing component 110 may perform offline training when the vehicle is not operating or otherwise stationary on a road. During the offline training, the computing component 110 may perform one or more steps, including step 412 and step 414.

At step 412, the computing component 110 may receive driver data. The driver data may include information on a driver of an ego vehicle. The driver data may include information, for example, the identification of the driver, characteristics of the driver (e.g., mood, driving skills, behaviors, etc.), driving performance (i.e., the driver's ability to navigate in various situations and environments), location of the ego vehicle (e.g., geographical location, lane of travel of the ego vehicle, etc.), direction of movement of the ego vehicle (e.g., destination, cardinal direction, etc.), and any other information related to the driver and driving performance of the ego vehicle. The driver data may be obtained from one or more sensors of the ego vehicle. The sensors may include, for example, cameras, image sensors, radar sensors, environmental sensors, light detection and ranging (LiDAR) sensors, position sensors, audio sensors, infrared sensors, microwave sensors, optical sensors, haptic sensors, magnetometers, communication systems and global positioning systems (GPS).

At step 414, the computing component 110 may determine driver preference of the driver. The driver preference of the driver may be determined by analyzing the driver data. The driver preference of the driver may be indicative of a default driving setting of the vehicle for the vehicle to operate in for the driver. The driver preference of the driver may be stored in a database for the driver. The driver preference of the driver may be retrieved for future use.

At step 420, the computing component 110 may perform online training. The computing component 110 may perform online training when the vehicle is operating or otherwise maneuvering on a road. During the online training, the computing component 110 may perform one or more steps, including step 422, step 424, step 426, and step 428.

At step 422, the computing component 110 may perform data collection. The computing component may collect driver data of a driver of an ego vehicle and environmental data of the ego vehicle. The ego vehicle may include, for example, an automobile, truck, motorcycle, bicycle, scooter, moped, recreational vehicle and other like on- or off-road vehicle. The ego vehicle may include, for example, an autonomous, semi-autonomous and manual operation. The ego vehicle may include one or more sensors that may be used to collect driver data and environmental data. The sensors may include, for example, cameras, image sensors, radar sensors, environmental sensors, light detection and ranging (LiDAR) sensors, position sensors, audio sensors, infrared sensors, microwave sensors, optical sensors, haptic sensors, magnetometers, communication systems and global positioning systems (GPS).

The computing component 110 may collect the driver data using at least one sensor of the ego vehicle. The computing component 110 may retrieve the driver data of the driver from the database storing driving preference information of the driver. The driver data may include information on the driver of the ego vehicle. The driver data may include information, for example, the identification of the driver, characteristics of the driver (e.g., mood, driving skills, behaviors, etc.), driving performance (i.e., the driver's ability to navigate in various situations and environments), location of the ego vehicle (e.g., geographical location, lane of travel of the ego vehicle, etc.), direction of movement of the ego vehicle (e.g., destination, cardinal direction, etc.), and any other information related to the driver and driving performance of the ego vehicle.

The computing component 110 may collect the environmental data using at least one sensor of the ego vehicle. The environmental data collected by the computing component 110 may be associated with a particular location of the ego vehicle. The environmental data of a particular location may include information on the condition of the road, damage to the road, hazardous features present on or proximate to the road, other attributes and characteristics of the road (e.g., the color, size, number of lanes, shape, etc.), traffic, number of vehicles on the road, and average speed of vehicles on the road. The computing component 110 may obtain environmental data collected by a plurality of other vehicles and computing components at or around the same location as the ego vehicle. The computing component 110 may associate, integrate, and combine the environmental data collected by other vehicles and computing components with the environmental data collected using at least one sensor of the ego vehicle to accurately record the environmental data of the ego vehicle.

At step 424, the computing component 110 may detect a driver discomfort signal. The computing component 110 may detect a signal indicative of driver discomfort of the driver of the ego vehicle. The signal indicative of driver discomfort may be detected when an actuating member of the driver (e.g., a foot of the driver) is in a proximity relative to a motion actuator of the vehicle (e.g., a brake pedal, accelerator pedal). The driver discomfort signal of the driver may indicate a degree of discomfort that the driver is experiencing while the ego vehicle is operating. The driver discomfort signal of the driver may indicate that a foot of the driver is hovering over or pressing on a brake pedal of the ego vehicle. A foot of the driver may hover over or press on the brake pedal of the ego vehicle when the driver is feeling uncomfortable while driving the ego vehicle. The driver may feel uncomfortable while driving the ego vehicle for various reasons, including, for example, bad weather, slow traffic, obstructions on the road, body irritation, etc. The driver discomfort signal of the driver may indicate that a foot of the driver is hovering over or pressing on an acceleration pedal of the ego vehicle. A foot of the driver may press on or hover over the acceleration pedal of the ego vehicle when the driver is feeling highly comfortable while driving the ego vehicle. The driver discomfort signal of the driver may indicate that a foot of the driver is placed away from the brake pedal and the acceleration pedal of the ego vehicle. A foot of the driver may be placed away from the brake pedal and the acceleration pedal when the driver is feeling neutrally comfortable while driving the vehicle. The driver may feel comfortable, whether highly or neutrally, while driving the ego vehicle for various reasons, including, for example, good weather, no traffic, no obstructions on the road, being happy, etc.

The computing component 110 may detect the driver discomfort signal using one or more internal sensors of the ego vehicle. The internal sensors of the ego vehicle may include, for example, cameras, radar sensors, electromyography sensors, motion sensors, pressure sensors, position sensors, and microwave sensors. The internal sensors may be located inside the ego vehicle and positioned in a manner to monitor the feet of the driver of the ego vehicle. One or more driver discomfort signals detected by the computing component 110 may be used to determine the degree of discomfort of the driver.

At step 426, the computing component 110 may determine discomfort. The computing component 110 may determine a discomfort level of the driver using the one or more driver discomfort signals detected. The one or more driver discomfort signals may be analyzed to determine the degree of discomfort of the driver of the ego vehicle while the ego vehicle is operating. The degree of discomfort of the driver may be used to determine a discomfort level of the driver. The discomfort level of the driver may be determined according to one or more factors of the driver discomfort signals, including, for example, the type of driver discomfort signals (e.g., brake pedal signal, acceleration pedal signal, and neutral position signal), the duration of each driver discomfort signal, the frequency of the driver discomfort signals (i.e., the rate of repetition of the foot brake pedal signals), the strength of the driver discomfort signals, etc. The discomfort level may be determined according to the driver data and the environmental data obtained at the same time or around the same time as the detection of the driver discomfort signals. Many variations are possible.

At step 428, the computing component 110 may generate a personalized ACC setting. The computing component 110 may use the driver data, environmental data and discomfort level of the driver in the ego vehicle to generate a personalized ACC setting for the driver. The personalized ACC setting for the driver may be a particular driving setting of the ego vehicle according to particular environmental data and driver data at a particular time, that the driver may feel comfortable for the ego vehicle to operate in. As an example, the personalized ACC setting for the driver may include a particular speed limit for the ego vehicle, a particular distance threshold of space between the ego vehicle and a leading vehicle, and a particular lane of traffic for the ego vehicle to operate in when the ego vehicle is operating on a particular road with particular driver data and particular environmental data that may place the driver in a comfortable and safe state. In this way, the ego vehicle may be able to automatically operate according to the personalized ACC setting without the driver's interference, and without the driver feeling uncomfortable. Various personalized ACC settings for the driver may be generated according to various combinations of environmental data, driver data, and discomfort level.

When the ego vehicle is operating according to a personalized ACC setting for the driver of the ego vehicle, the computing component 110 may detect one or more new driver discomfort signals of the driver. A new discomfort level of the driver may be determined according to the new driver discomfort signals. The personalized ACC setting may be updated according to the new discomfort level of the driver. The computing component 110 may operate the ego vehicle according to the updated personalized ACC setting. The computing component 110 may store the updated personalized ACC setting in the database. In this way, the personalized ACC settings for the driver stored in the database may accurately reflect the driving performance preferences of the driver to allow the ego vehicle to operate without interference from the driver, and without the driver feeling uncomfortable and unsafe.

The computing component 110 may repeat steps 424, 426 and 428 when additional driver discomfort signals are detected to determine new discomfort levels of the driver that may be used to update an existing personalized ACC setting. The computing component 110 may repeat steps 422, 424, 426 and 428 when the computing component 110 collects new environmental data or new driver data, or both, to generate a new personalized ACC setting.

For simplicity of description, the process 400 is described as being performed with respect to a single personalized ACC setting. It should be appreciated that, in a typical embodiment, the computing component 110 may manage a change in the environmental data, driver data and discomfort level of the driver, at various times, in short succession of one another. For example, in some embodiments, the computing component 110 can perform many, if not all, of the steps in process 400 on a plurality of combinations of data to generate and update various personalized ACC settings for the driver.

FIG. 5 illustrates an example computing component 500 that includes one or more hardware processors 502 and machine-readable storage media 504 storing a set of machine-readable/machine-executable instructions that, when executed, cause the hardware processor(s) 502 to perform an illustrative method of generating personalized adaptive cruise control (ACC) settings. It should be appreciated that there can be additional, fewer, or alternative steps performed in similar or alternative orders, or in parallel, within the scope of the various examples discussed herein unless otherwise stated. The computing component 500 may be implemented as the computing component 110 of FIG. 1, the computing system 210 of FIG. 2, the personalized ACC system 300 of FIG. 3, and the process 400 of FIG. 4.

At step 506, the hardware processor(s) 502 may execute machine-readable/machine-executable instructions stored in the machine-readable storage media 504 to receive environmental data of a vehicle and driver data of a driver of the vehicle. A vehicle traveling on a road may collect environmental data. The vehicle may include, for example, an automobile, truck, motorcycle, bicycle, scooter, moped, recreational vehicle and other like on- or off-road vehicles. The vehicle may include, for example, an autonomous, semi-autonomous and manual operation. The vehicle may include one or more sensors that may be used to collect environmental data of the vehicle and driver data of a driver of the vehicle. The sensors may include, for example, a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS). Data may be received by at least one sensor of the vehicle.

The environmental data may include information including, for example, the time (e.g., minute, hour, day, month, and year), weather, road conditions, traffic, average speed of vehicles on the road, damages to the road, hazardous features on the road, obstructions on the road, and attributions of the road (e.g., the color, size, number of lanes, shape, etc.). The environmental data collected may be associated with a location of the vehicle. The environmental data may be associated, integrated, and combined together and with environmental data collected by other vehicles at or near the location of the vehicle.

The driver data may include information including, for example, the identification of the driver, characteristics of the driver (e.g., mood, driving skills, behaviors, etc.), driving performance (i.e., the driver's ability to navigate in various situations and environments), location of the vehicle (e.g., geographical location, lane of travel of the ego vehicle, etc.), and direction of movement of the vehicle (e.g., destination, cardinal direction, etc.). The driver data collected may be associated with the driver of the vehicle and the driving performance of the vehicle by the driver.

At step 508, the hardware processor(s) 502 may execute machine-readable/machine-executable instructions stored in the machine-readable storage media 504 to detect a signal indicative of driver discomfort. The vehicle may include one or more sensors that may be used to detect a signal indicative of driver discomfort of the driver of the vehicle. The sensors may include, for example, a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS). The driver discomfort signal of the driver may be detected by at least one sensor of the vehicle.

The signal indicative of driver discomfort may be detected when an actuating member of the driver (e.g., a foot of the driver) is in a proximity relative to a motion actuator of the vehicle (e.g., a brake pedal, accelerator pedal). The driver discomfort signal of the driver may indicate that a foot of the driver is hovering over or pressing on a brake pedal of the vehicle. A foot of the driver may hover over or press on the brake pedal of the vehicle when the driver is feeling uncomfortable while driving the vehicle. The driver may feel uncomfortable while driving the vehicle for various reasons, including, for example, bad weather, slow traffic, obstructions on the road, body irritation, etc. The driver discomfort signal of the driver may indicate that a foot of the driver is hovering over or pressing on an acceleration pedal of the vehicle. A foot of the driver may press on or hover over the acceleration pedal of the vehicle when the driver is feeling highly comfortable while driving the vehicle. The driver discomfort signal of the driver may indicate that a foot of the driver is placed away from the brake pedal and the acceleration pedal of the vehicle. A foot of the driver may be placed away from the brake pedal and the acceleration pedal when the driver is feeling neutrally comfortable while driving the vehicle. The driver may feel comfortable, whether highly or neutrally, while driving the vehicle for various reasons, including, for example, good weather, no traffic, no obstructions on the road, being happy, etc.

At step 510, the hardware processor(s) 502 may execute machine-readable/machine-executable instructions stored in the machine-readable storage media 504 to determine a discomfort level of the driver according to the signal. The driver discomfort signal of the driver may indicate a degree of discomfort that the driver is experiencing while the vehicle is operating. The driver discomfort signal of the driver detected may be analyzed to determine a discomfort level of the driver while the vehicle is operating. The discomfort level may be determined according to one or more factors of the driver discomfort signal, including, for example, the type of driver discomfort signals (e.g., brake pedal signal, acceleration pedal signal, and neutral position signal), the duration of each driver discomfort signal, the frequency of the driver discomfort signals (i.e., the rate of repetition of the brake pedal signals), the strength of the driver discomfort signals, etc. The discomfort level of the driver may be determined according to the degree of discomfort of the driver that is determined from the driver discomfort signal. The discomfort level may be determined according to the driver data and the environmental data obtained at the same time or around the same time as the detection of the driver discomfort signal. Many variations are possible.

At step 512, the hardware processor(s) 502 may execute machine-readable/machine-executable instructions stored in the machine-readable storage media 504 to generate a personalized ACC setting for the driver according to the discomfort level, environmental data and driver data. The driver data, environmental data and discomfort level of the driver in the vehicle may be used to generate a personalized ACC setting for the driver. The personalized ACC setting for the driver may be a particular driving setting of the vehicle according to particular environmental data and driver data at a particular time, where the driver may feel comfortable with the vehicle operating in. As an example, the personalized ACC setting for the driver may include a particular speed limit for the ego vehicle, a particular distance threshold of space between the ego vehicle and a leading vehicle, and a particular lane of traffic for the ego vehicle to operate in when the ego vehicle is operating on a particular road with particular driver data and particular environmental data that may place the driver in a comfortable and safe state. In this way, the vehicle may be able to automatically operate according to the personalized ACC setting without interference from the driver, and without the driver feeling uncomfortable and unsafe. Various personalized ACC settings for the driver may be generated according to various combinations of environmental data, driver data, and discomfort level.

At step 516, the hardware processor(s) 502 may execute machine-readable/machine-executable instructions stored in the machine-readable storage media 504 to send the personalized ACC setting to the vehicle for implementation. The personalized ACC setting for the driver may be sent to the vehicle. The vehicle may implement the personalized ACC setting and operate according to the personalized ACC setting.

At step 516, the hardware processor(s) 502 may execute machine-readable/machine-executable instructions stored in the machine-readable storage media 504 to store the personalized ACC setting for the driver in a driver preference database. The personalized ACC setting for the driver may be stored in a driver preference database of the driver. In this way, a plurality of personalized ACC settings for the driver generated according to various combinations of environmental data, driver data, and discomfort level may be stored and retrieved for future use.

When the vehicle is operating according to a personalized ACC setting for the driver of the vehicle, one or more data of the environmental data or driver data may change. The vehicle may receive the updated environmental data or updated driver data and retrieve a stored personalized ACC setting from the database that matches the new set of data of the environmental data and driver data. The vehicle may update its operations to the newly retrieved stored personalized ACC setting from the database.

When the vehicle is operating according to a personalized ACC setting for the driver of the vehicle, one or more new driver discomfort signals of the driver may be detected. A new discomfort level of the driver may be determined according to the new driver discomfort signals. The personalized ACC setting may be updated according to the new discomfort level of the driver. The updated personalized ACC setting may be stored in the database. In this way, the personalized ACC settings for the driver stored in the database may accurately reflect the driving performance preferences of the driver to allow the vehicle to operate without interference from the driver, and without the driver feeling uncomfortable and unsafe.

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 6. Various applications are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a vehicle (e.g., vehicle 150, vehicle 200), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability. In another example, a computing component might be found in components making up vehicle 150, vehicle 200, personalized adaptive cruise control (ACC) circuit 310, decision and control circuit 303, computing system 100, computing system 210, ECU 225, etc.

Computing component 600 might include, for example, one or more processors, controllers, control components, or other processing devices. This can include a processor, and any one or more of the components making up vehicle 150 of FIG. 1, vehicle 200 of FIG. 2, computing system 210 of FIG. 2, and personalized ACC system 300 of FIG. 3. Processor 604 might be implemented using a general-purpose or special-purpose processing engine such as, for example, a microprocessor, controller, or other control logic. The processor 604 might be specifically configured to execute one or more instructions for execution of logic of one or more circuits described herein, such as personalized ACC circuit 310, decision and control circuit 303, and logic for control systems 240. Processor 604 may be configured to execute one or more instructions for performing one or more methods, such as the process described in FIG. 4 and the method described in FIG. 5.

Processor 604 may be connected to a bus 602. However, any communication medium can be used to facilitate interaction with other components of computing component 600 or to communicate externally. In applications, processor 604 may fetch, decode, and execute one or more instructions to control processes and operations for enabling vehicle servicing as described herein. For example, instructions can correspond to steps for performing one or more steps of the process described in FIG. 4 and the method described in FIG. 5.

Computing component 600 might also include one or more memory components, simply referred to herein as main memory 608. For example, random access memory (RAM) or other dynamic memory, might be used for storing information and instructions to be fetched, decoded, and executed by processor 604. Such instructions may include one or more instructions for execution of one or more logical circuits described herein. Instructions can include instructions 208 of FIG. 2, and instructions 309 of FIG. 3 as described herein, for example. Main memory 608 might also be used for storing temporary variables or other intermediate information during execution of instructions to be fetched, decoded, and executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative applications, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage unit 622 and interface 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computer implemented method for generating a personalized Adaptive Cruise Control (ACC) setting for driver comfort, the method comprising:
receiving environmental data of a vehicle and driver data of a driver of the vehicle;
detecting a signal indicative of driver discomfort;
determining a discomfort level of the driver according to the signal;
generating the personalized ACC setting for the driver according to the discomfort level, environmental data and driver data;
sending, to the vehicle, the personalized ACC setting for the vehicle to implement; and
storing the personalized ACC setting for the driver in a driver preference database.

2. The method of claim 1, wherein the environmental data, the driver data and the signal are obtained from a sensor of the vehicle.

3. The method of claim 2, wherein the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

4. The method of claim 1, wherein the environmental data comprises a time, weather, road condition and traffic.

5. The method of claim 1, wherein the driver data comprises a location of the vehicle, direction of movement of the vehicle, driver identification and driver performance characteristic.

6. The method of claim 1, wherein the personalized ACC setting is adjusted according to a change in the discomfort level of the driver.

7. The method of claim 1, wherein the signal indicative of driver discomfort is a proximity of an actuating member of the driver relative to a motion actuator of the vehicle.

8. The method of claim 1, further comprising:
obtaining the personalized ACC setting according to the environmental data and driver data;
sending, to the vehicle, the personalized ACC setting for the vehicle to implement;
detecting a second signal indicative of driver discomfort;
determining a second discomfort level of the driver according to the second signal;
updating the personalized ACC setting according to the second discomfort level, environmental data and driver data;
sending, to the vehicle, the updated personalized ACC setting for the vehicle to implement; and
storing the updated personalized ACC setting in the driver preference database.

9. A computer system for generating a personalized Adaptive Cruise Control (ACC) setting for driver comfort, the system comprising:
one or more processors; and
memory coupled to the one or more processors to store instructions, which when executed by the one or more processors, cause the one or more processors to perform operations, the operations comprising:
receiving environmental data of a vehicle and driver data of a driver of the vehicle;
detecting a signal indicative of discomfort;
determining a discomfort level of the driver according to the signal;
generating the personalized ACC setting for the driver according to the discomfort level, environmental data and driver data;
sending, to the vehicle, the personalized ACC setting for the vehicle to implement; and
storing the personalized ACC setting for the driver in a driver preference database.

10. The system of claim 9, wherein the environmental data, the driver data and the signal are obtained from a sensor of the vehicle.

11. The system of claim 10, wherein the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

12. The system of claim 9, wherein the environmental data comprises a time, weather, road condition and traffic.

13. The system of claim 9, wherein the driver data comprises a location of the vehicle, direction of movement of the vehicle, driver identification and driver performance characteristic.

14. The system of claim 9, wherein the personalized ACC setting is adjusted according to a change in the discomfort level of the driver.

15. The system of claim 9, wherein the signal indicative of driver discomfort is a proximity of an actuating member of the driver relative to a motion actuator of the vehicle.

16. The system of claim 9, wherein the operations further comprise:
obtaining the personalized ACC setting according to the environmental data and driver data;
sending, to the vehicle, the personalized ACC setting for the vehicle to implement;
detecting a second signal indicative of driver discomfort;
determining a second discomfort level of the driver according to the second signal;
updating the personalized ACC setting according to the second discomfort level, environmental data and driver data;
sending, to the vehicle, the updated personalized ACC setting for the vehicle to implement; and
storing the updated personalized ACC setting in the driver preference database.

17. A non-transitory machine-readable medium having instructions stored therein, which when executed by a processor, cause the processor to perform operations, the operations comprising:
receiving environmental data of a vehicle and driver data of a driver of the vehicle;
detecting a signal indicative of driver discomfort;
determining a discomfort level of the driver according to the signal;
generating a personalized ACC setting for the driver according to the discomfort level, environmental data and driver data;
sending the personalized ACC setting to the vehicle for implementation; and
storing the personalized ACC setting for the driver in a driver preference database.

18. The non-transitory machine-readable medium of claim 17, wherein the environmental data, the driver data and the signal are obtained from a sensor of the vehicle and the sensor comprises at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

19. The non-transitory machine-readable medium of claim 17, wherein the signal indicative of driver discomfort is a proximity of an actuating member of the driver relative to a motion actuator of the vehicle.

20. The non-transitory machine-readable medium of claim 17, wherein the operations further comprise:
obtaining the personalized ACC setting according to the environmental data and driver data;
sending the personalized ACC setting to the vehicle for implementation;
detecting a second signal indicative of driver discomfort;
determining a second discomfort level of the driver according to the second signal;
updating the personalized ACC setting according to the second discomfort level, environmental data and driver data;
sending the updated personalized ACC setting to the vehicle for implementation; and
storing the updated personalized ACC setting in the driver preference database.
